(19) United States
(12) Patent Application Publication
(10) Pub. No.: US 2011/0260435 A1
(43) Pub. Date: Oct. 27, 2011

(54) VEHICLE SEAT SYSTEM

(75) Inventors: HSUEH-FENG HSU, Tu-Cheng (TW); HAI LAN, Tu-Cheng (TW)

(73) Assignee: HON HAI PRECISION INDUSTRY CO., LTD., Tu-Cheng (TW)

(21) Appl. No.: 12/913,785

(22) Filed: Oct. 28, 2010

(30) Foreign Application Priority Data
Apr. 21, 2010 (TW) 99112499

(51) Int. Cl. B60R 21/16

(52) U.S. Cl. 280/735

(57) ABSTRACT

An exemplary vehicle seat system includes a vehicle seat, an electronic control unit, a crash detection unit connected with the control unit, a seat occupancy sensing module configured for sensing an occupancy of the seat and generating a digital signal associated therewith, an airbag, and an airbag inflating module. The detection unit detects a crash and sends a crash signal associated therewith to the control unit. The inflating module is selectively operable in an activated mode where the inflating module is configured to inflate the airbag in response to the crash signal and an inactivated mode where the inflating module is deactivated and irresponsive to the crash signal. The control unit analyzes the digital signal and determining if the vehicle seat is occupied, and switches the inflating module either in the activated mode if the seat is occupied or in the inactivated mode if the seat is not occupied.

### BACKGROUND

1. Technical Field

The present disclosure relates to automotive technology, and particularly, to a seat system with airbag deployment control for a vehicle.

2. Description of Related Art

Generally, vehicles employ airbags for protecting occupants in a car crash. However, because all bags deploy no matter whether there are occupants to protect or not, great expense is incurred.

Therefore, it is desirable to provide a vehicle seat system, which can overcome the above mentioned limitations.

### BRIEF DESCRIPTION OF THE DRAWINGS

FIG. 1 is a schematic view of a vehicle seat system according to a first embodiment.

FIG. 2 is a schematic cross-section view of the vehicle seat system of

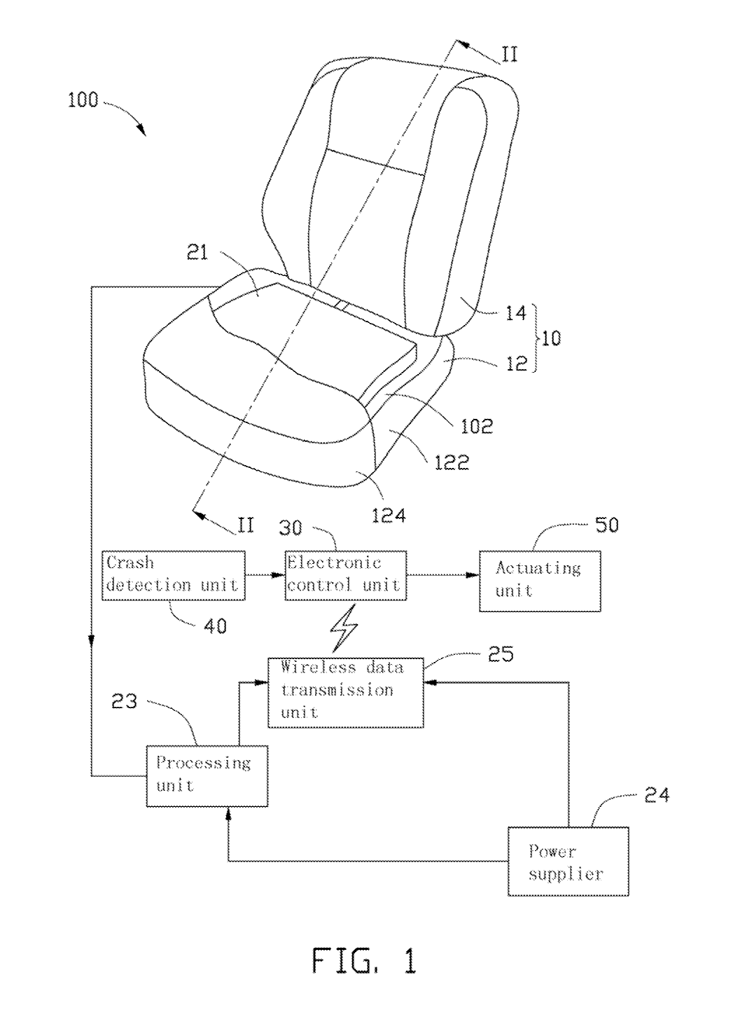

FIG. 1, taken along the line II-II thereof.

FIG. 3 is a schematic view of a vehicle seat system according to a second embodiment.

FIG. 4 is a schematic view of a vehicle seat system according to a third embodiment.

FIG. 5 is a schematic cross-section view of the vehicle seat system of FIG. 4, taken along the line V-V thereof.

### DETAILED DESCRIPTION

Embodiments will now be described in detail below with reference to drawings. In this description, unless the context indicates otherwise, it is accepted that a micro-electro-mechanical-system (MEMS) means an integrative micro-device system that consists of micro-sensor, micro-actuator, controlling and signal processing circuit, interface circuit, communication interface and electrical source. Similarly, unless the context indicates otherwise, a MEMS pressure sensor means a pressure sensor that measures pressure by MEMS. The MEMS pressure sensor can be a resistance MEMS pressure sensor, a capacitive MEMS pressure sensor, and etc.

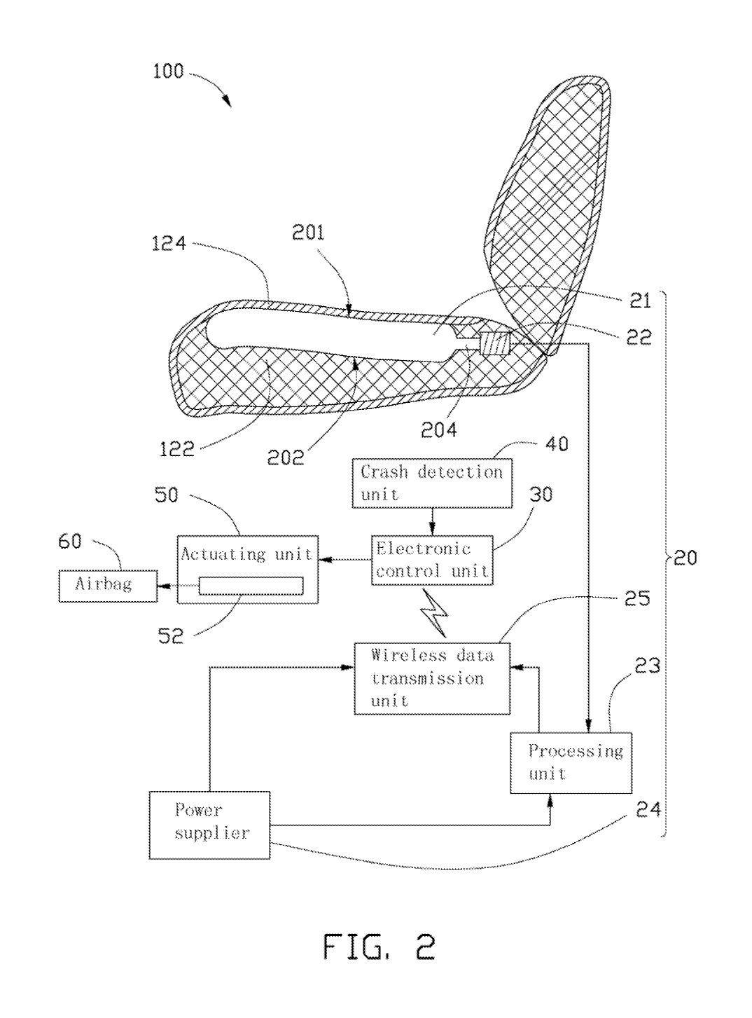

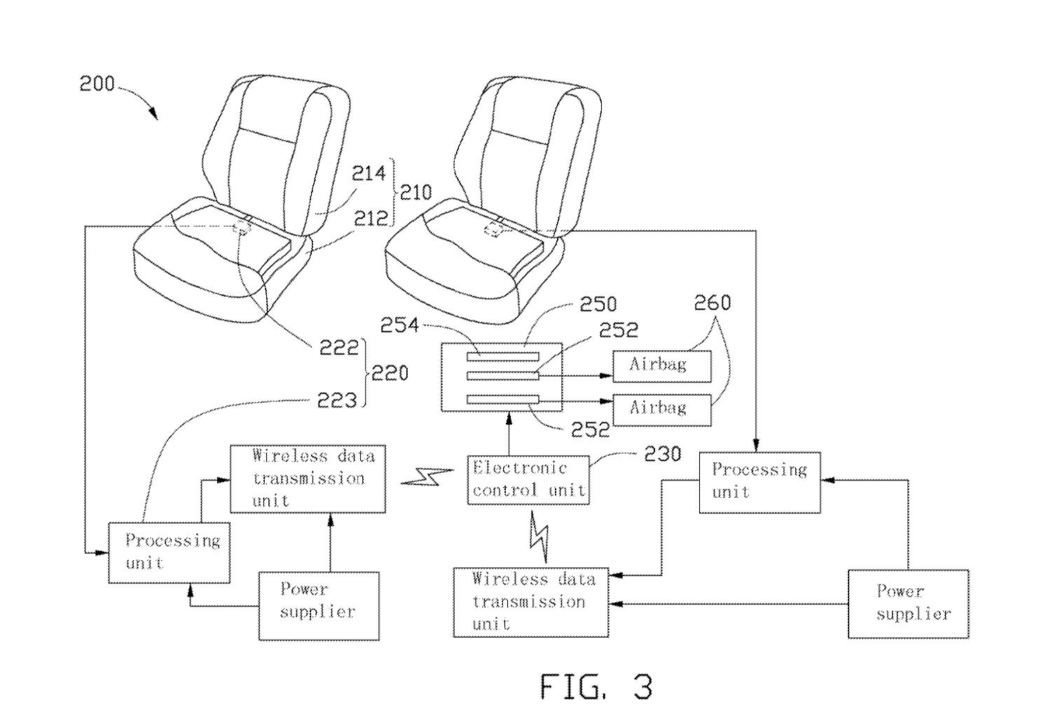

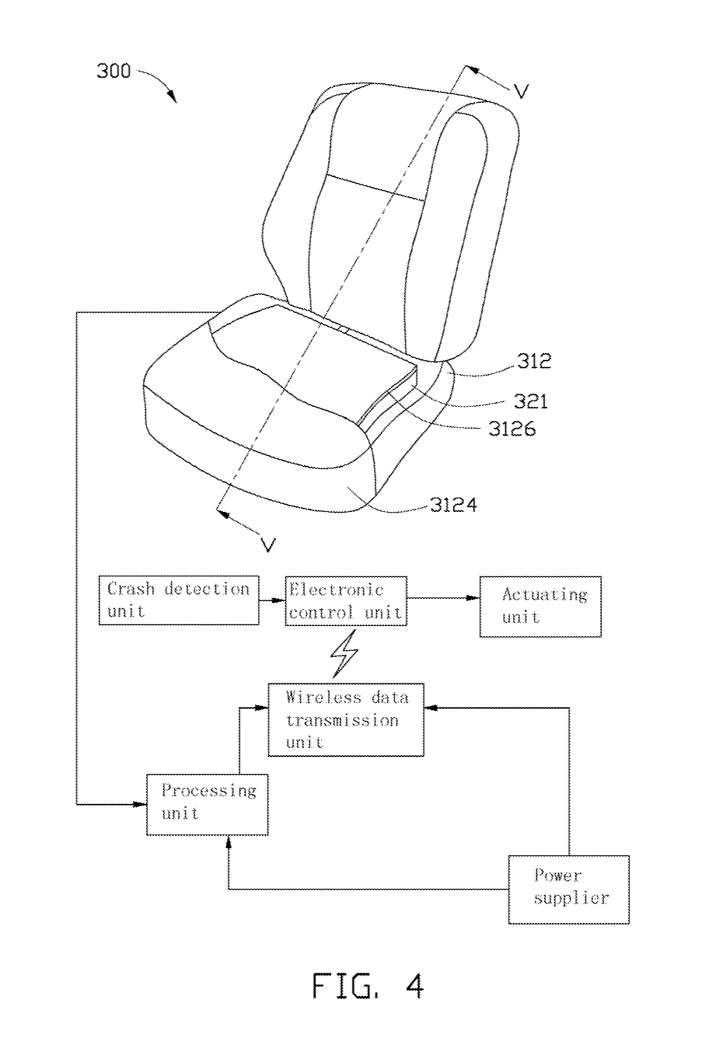

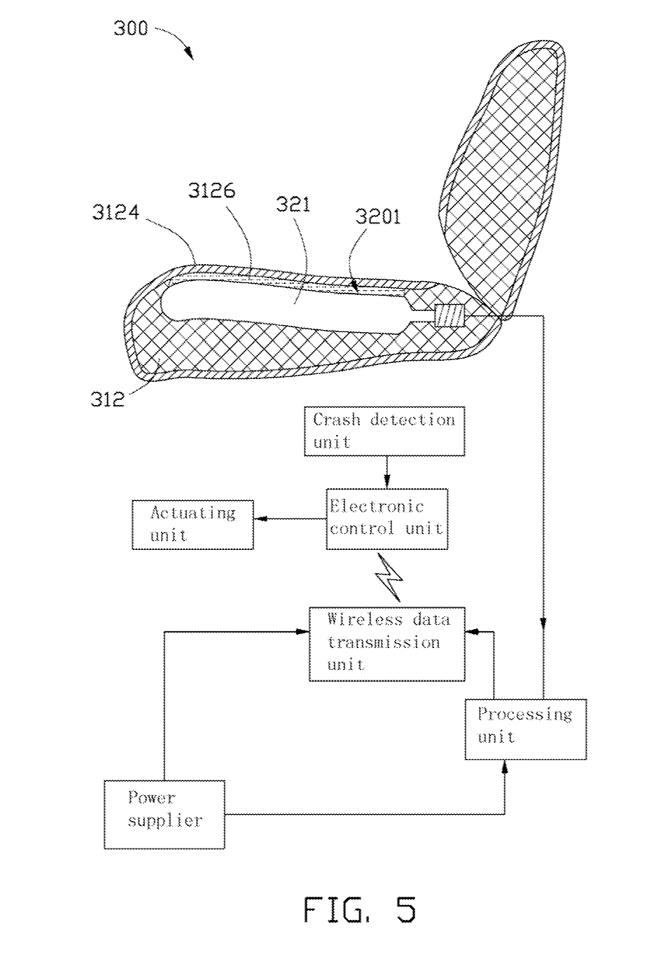

Referring to FIGS. 1-2, a vehicle seat system 100, in accordance with a first embodiment, is shown. The vehicle seat system 100 includes a vehicle seat 10, a seat occupancy sensing module 20, an electronic control unit 30, a crash detection unit 40, an actuating unit 50, and an airbag 60.

The vehicle seat 10 includes a horizontally situated bottom seat portion 12, and a vertically oriented back portion 14 connected with the seat portion 12. The seat portion 12 includes a cushion 122, and a packaging layer 124 packaging the cushion 122. A receiving cavity 102 is cooperatively defined by the cushion 122 and the packaging layer 124.

The seat occupancy sensing module 20 is configured for sensing an occupancy of the seat portion 12 of the vehicle seat 10 and generating a digital signal associated therewith. The seat occupancy sensing module 20 includes a pressure sensing bag 21, and a MEMS pressure sensor 22, a processor unit 23, and a power supplier 24 for supplying electrical power to the processor unit 23.

The pressure sensing bag 21 is disposed in the seat portion 12. In the present embodiment, the pressure sensing bag 21 is received in the receiving cavity 102 of the seat portion 12. The pressure sensing bag 21 includes an upper surface 201, and a lower surface 202 opposite to the upper surface 201. The upper surface 201 is adjacent to the packaging layer 124. The lower surface 202 is adjacent to the upper surface of the cushion 122. The pressure sensing bag 21 also includes a neck portion 204 with a width less than that of other portions thereof. The pressure sensing bag 21 is made of a material capable of elastic distortion. In the present embodiment, the pressure sensing bag 21 is made of rubber. The pressure sensing bag 21 is filled with gas or fluid. If the seat portion 12 is occupied by an occupant (not shown), the pressure sensing bag 21 compresses, and then generates pressure at the neck portion 204. On the contrary, if the occupant leaves the seat portion 12, the pressure sensing bag 21 returns to its original state.

The MEMS pressure sensor 22 is disposed at the neck portion 204 of the pressure sensing bag 21. The MEMS pressure sensor 22 is configured for sensing pressure applied to the pressure sensing bag 21 by the occupant (i.e., the weight of the occupant), and providing a pressure sensing output signal in response to the sensed pressure.

The processing unit 23 is electrically connected with the MEMS pressure sensor 22. The processing unit 23 is configured for processing (e.g. demodulating, correcting, compensating) the pressure sensing output signal from the MEMS pressure sensor 22, and finally generating and outputting a digital signal associated with the occupancy of the seat portion 12. That is, the processing unit 23 finally outputs the digital signal based on a pressure condition on the seat portion 12. In the present embodiment, the processing unit 23 is electrically connected with the MEMS pressure sensor 22 by data transmission channel (not shown), and is a micro processing integrated circuit. The digital signal is transmitted to the processing unit 23 by the data transmission channel.

The crash detection unit 40 is connected to the electronic control unit 30. The crash detection unit 40 includes, for example, crash detection sensors on a vehicle, an acceleration sensor, and the like. The crash detection unit 40 detects a crash of the vehicle and sends a crash signal associated therewith to the electronic control unit 30.

The actuating unit 50 is electrically connected with the electronic control unit 30, and includes an airbag inflator module 52. The inflator module 52 is selectively operable in an activated mode where the airbag inflating module 52 is configured to inflate an airbag 60 in response to the crash signal and an inactivated mode where the airbag inflating module 52 is deactivated and irresponsive to the crash signal.

The electronic control unit 30 analyzes the digital signal, and determines if the seat portion 12 of the vehicle seat 10 is occupied. The electronic control unit 30 is configured for switching the airbag inflating module 52 to the activated mode if the seat portion 12 of the vehicle seat 10 is occupied and switching the airbag inflating module 52 to the inactivated mode if the seat portion 12 of the vehicle seat 10 is not occupied.

When the vehicle seat system 100 experiences a crash, and there is no occupant in the vehicle seat 10 sensed by the seat occupancy sensing module 20, the electronic control unit 30 prevents the airbag 60 from being inflated, thereby reducing the cost of the vehicle seat system 100. In addition, no matter whether an occupant sits at the center of the cushion 122 or not, the MEMS pressure sensor 22 can sense the pressure applied to the pressure sensing bag 21. The sensitivity and the reliability of the pressure sensing are thus improved.

The seat occupancy sensing module 20 may also includes a wireless data transmission unit 25. The wireless data transmission unit 25 is electronically connected with the processing unit 23, thereby receiving the digital signal from the processing unit 23, and transmitting the digital signal to the electronic control unit 30. In the present embodiment, the wireless data transmission unit 25 is a BLUETOOTH transmission unit 25; the power supplier 24 may be a battery pack. The power supplier 24 supplies electrical power to the wireless data transmission unit 25 and the processing unit 23. In other embodiments, the wireless data transmission unit 25 may be a Wi-Fi transmission unit.

Referring to FIG. 3, a vehicle seat system 200, in accordance with a second embodiment, is shown. The vehicle seat system 200 is similar to the vehicle seat system 100, and includes a plurality of vehicle seats 210, a plurality of seat occupancy sensing modules 220 mounted to the respective vehicle seats 210, an electronic control unit 230, a crash detection unit (not shown), an actuating unit 250, and a plurality of airbag 260.

Each of the vehicle seats 210 includes a seat portion 212 and a back portion 214. The actuating unit 250 includes a plurality of airbag inflator modules 252 corresponding to the respective MEMS pressure sensing modules 220, and a suspension system 254 for stabilizing the vehicle seat system 200.

Each seat occupancy sensing module 200 is configured for sensing an occupancy of the seat portion 212 of the responding vehicle seat 210 and generating a digital signal associated therewith. Each seat occupancy sensing module 220 includes a MEMS pressure sensor 222, and a processing unit 223. The MEMS pressure sensor 222 is configured for sensing the pressure applied to the seat portion 212, and providing a pressure sensing output signal proportional to the sensed pressure. The processing unit 223 receives the pressure sensing output signal, processes the pressure sensing output signal, and generates and outputs a digital signal.

The crash detection unit is the same as the crash detection unit 40, and detects a crash of the vehicle and sends a crash signal associated therewith to the electronic control unit 230.

Each actuating unit 250 includes an airbag inflating module 252. The airbag inflating modules 252 are coupled to the corresponding airbags 260. Each airbag inflating module 252 is selectively operable in an activated mode where the airbag inflating module 252 is configured to inflate the corresponding airbag 260 in response to the crash signal and an inactivated mode where the airbag inflating module 252 is deactivated and irresponsive to the crash signal.

The electronic control unit 230 analyzes the digital signals and determines which the seat portion 212 of the vehicle seat 210 is occupied. The electronic control unit 230 can switch the corresponding airbag inflating module 252 to the activated mode if the corresponding seat portion 212 is occupied, and switch the corresponding airbag inflating module 252 to the inactivated mode if the corresponding seat portion 212 is not occupied. In addition, the electronic control unit 230 can determine a pressure distribution according to from the digital signals, and generate a stabilization signal in response to the pressure distribution for the suspension system 254.

According to the stabilization signal for the suspension system 254, the suspension system 254 stabilizes the vehicular system 200 to make the occupants more comfortable. In the present embodiment, the suspension system 254 stabilizes the vehicular system 200 by adjusting hydraulic equilibrium system (not shown) of the suspension system 254.

Referring to FIGS. 4-5, a vehicle seat system 300, in accordance with a third embodiment, is shown. The vehicle seat system 300 is similar to the vehicle seat system 100, and includes a seat portion 321 with a package layer 3124, and a pressure sensing bag 321 with an upper surface 3201. In addition, the vehicle seat system 300 also includes a medium layer 3126 disposed between the package layer 3124 of the seat portion 312 and the upper surface 3201 of the pressure sensing bag 321. The medium layer 3126 is configured for transmitting pressure to the pressure sensing bag 321, and protecting the pressure sensing bag 321 from being damaged. In the present embodiment, the medium layer 3126 is a liquid cushion. In other embodiments, the medium layer 3126 may be an air cushion, a silica gel cushion, a spring cushion, etc.

While certain embodiments have been described and exemplified above, various other embodiments will be apparent to those skilled in the art from the foregoing disclosure. The disclosure is not limited to the particular embodiments described and exemplified but is capable of considerable variation and modification without departure from the scope and spirit of the appended claims.

What is claimed is:

1. A vehicle seat system comprising:
a vehicle seat having a seat portion;
an electronic control unit;
a crash detection unit connected with the electronic control unit, the crash detection unit configured for detecting a crash and sending a crash signal associated therewith to the electronic control unit;
a seat occupancy sensing module configured for sensing an occupancy of the vehicle seat and generating a digital signal associated therewith;
an airbag, and an airbag inflating module selectively operable in an activated mode where the airbag inflating module is configured to inflate the airbag in response to the crash signal and an inactivated mode where the airbag inflating module is deactivated and irresponsive to the crash signal; the electronic control unit configured for analyzing the digital signal and determining if the vehicle seat is occupied, and switching the airbag inflating module to the activated mode if the seat is occupied and switching the airbag inflating module to the inactivated mode if the seat is not occupied.

2. The vehicle seat system of claim 1, wherein the seat occupancy sensing module comprises a pressure sensing bag, a MEMS pressure sensor connected with the pressure sensing bag, and a processing unit connected with the MEMS pressure sensor, the pressure sensing bag is disposed in the seat portion, and is compressible when the seat portion is occupied, the MEMS pressure sensor is configured for sensing a pressure applied to the pressure sensing bag, and providing a pressure sensing output signal in response to the sensed pressure, the processing unit is configured for receiving and processing the pressure sensing output signal, and generating and outputting the digital signal.

3. The vehicle seat system of claim 2, wherein the seat portion comprises a cushion, a packaging layer packaging the cushion, and a receiving cavity cooperatively defined by the cushion and the packaging layer, the pressure sensing bag is received in the receiving cavity.

4. The vehicle seat system of claim 3, wherein the pressure sensing bag comprises an upper surface, and a lower surface opposite to the upper surface, the upper surface is adjacent to the packaging layer, and the lower surface is adjacent to an upper surface of the cushion.

5. The vehicle seat system of claim 4, further comprising a medium layer, the medium layer is disposed between the package layer of the seat portion and the upper surface of the pressure sensing bag.

6. The vehicle seat system of claim 2, wherein the pressure sensing bag comprises a neck portion with a width less than that of other portions thereof, and the MEMS pressure sensor disposed at the neck portion.

7. The vehicle seat system of claim 2, wherein the seat occupancy sensing module further comprise a wireless data transmission unit, the wireless data transmission unit is electrically connected with the processing unit, thereby receiving the digital signal from the processing unit, and transmitting the digital signal to the electronic control unit.

8. The vehicle seat system of claim 2, wherein the MEMS pressure sensor is a resistance MEMS pressure sensor or a capacitive MEMS pressure sensor.

9. The vehicle seat system of claim 2, wherein the processing unit is a micro processing integrated circuit.

10. A vehicle seat system comprising:
a plurality of vehicle seats, each of the vehicle seats having a seat portion;
an electronic control unit; and
a crash detection unit connected with the electronic control unit, the crash detection unit configured for detecting a crash and outputting a crash signal associated with the crash to the electronic control unit;
a plurality of seat occupancy sensing modules mounted to the respective vehicle seats, each seat occupancy sensing module configured for sensing an occupancy of the vehicle seat and generating a digital signal associated therewith;
a plurality of airbags, and
a plurality of airbag inflating modules coupled to the corresponding airbags, each airbag inflating module being selectively operable in an activated mode where the airbag inflating module is configured to inflate the corresponding airbag in response to the crash signal and an inactivated mode where the airbag inflating module is deactivated and irresponsive to the crash signal; the electronic control unit configured for analyzing the digital signals and determining which vehicle seat is occupied, the electronic control unit configured for switching the corresponding airbag inflating module to the activated mode if the corresponding seat is occupied, the electronic control unit configured for switching the airbag inflating module to the inactivated mode if the corresponding seat is not occupied.

11. The vehicle seat system of claim 10, wherein each of seat occupancy sensing modules comprises a pressure sensing bag, a MEMS pressure sensor connected with the pressure sensing bag, and a processing unit connected with the MEMS pressure sensor, each of the pressure sensing bags is disposed in the corresponding seat portion, and is compressible when the corresponding seat portion is occupied, each of the MEMS pressure sensors is configured for sensing a pressure applied to the corresponding pressure sensing bag, and providing a pressure sensing output signal in response to the corresponding sensed pressure, each of the processing unit is configured for receiving and processing the corresponding pressure sensing output signal, and generating the digital signal.

12. The vehicle seat system of claim 11, wherein each of the seat portions comprises a cushion, a packaging layer packaging the cushion, and a receiving cavity cooperatively defined by the cushion and the packaging layer, the pressure sensing bags are received in the corresponding receiving cavities.

13. The vehicle seat system of claim 12, wherein each of the pressure sensing bags comprises an upper surface, and a lower surface opposite to the upper surface, each of the upper surfaces is adjacent to the corresponding packaging layer, each of the lower surfaces is adjacent to the upper surface of the corresponding cushion.

14. The vehicle seat system of claim 13, further comprising a plurality of medium layers, each of the medium layers is disposed between the package layer of the corresponding seat portion and the upper surface of the corresponding pressure sensing bag.

15. The vehicle seat system of claim 11, wherein each of the pressure sensing bags comprises a neck portion with a width less than that of other portions thereof, and each of the MEMS pressure sensors disposed at the corresponding neck portion.

16. The vehicle seat system of claim 11, wherein each of the MEMS pressure sensing modules further comprise a wireless data transmission unit, each of the wireless data transmission units is electrically connected with the corresponding processing unit, thereby receiving the corresponding digital signal from the corresponding processing unit, and transmitting the corresponding digital signal to the electronic control unit.

17. The vehicle seat system of claim 11, wherein each of the MEMS pressure sensors is a resistance MEMS pressure sensor or a capacitive MEMS pressure sensor.

18. The vehicle seat system of claim 11, further comprising a suspension system, the electronic control unit is configured for determining a pressure distribution according to the digital signals, and generates a stabilization signal in response to the pressure distribution for the suspension system, the suspension system is configured for stabilizing the vehicle seat system in response to the stabilization signal.
